(19) United States
(12) Patent Application Publication
(10) Pub. No.: US 2012/0233237 A1
(43) Pub. Date: Sep. 13, 2012

(54) DYNAMIC DATA TRANSACTION PROCESSING USING GATING CRITERIA

(75) Inventors: Humberto Enrique Roa, Bainbridge Island, WA (US); Kenji Hiroshi Kato, San Jose, CA (US); Sen Guan Wen, Bainbridge Island, WA (US); Carlos Sola-Llonch, Seattle, WA (US); Rohan Ramesh Singh, Seattle, WA (US); Shannon Meade Roa, Bainbridge Island, WA (US)

(73) Assignee: Project Fastlane, Inc., Bainbridge Island, WA (US)

(21) Appl. No.: 13/417,319

(22) Filed: Mar. 11, 2012

Related U.S. Application Data
(63) Continuation-in-part of application No. 13/219,480, filed on Aug. 26, 2011.
(60) Provisional application No. 61/452,066, filed on Mar. 11, 2011.
(60) Provisional application No. 61/452,066, filed on Mar. 11, 2011.
(60) Provisional application No. 61/377,438, filed on Aug. 26, 2010.

(51) Int. Cl. G06F 15/16

(52) U.S. Cl. 709/201

(57) ABSTRACT

Techniques for dynamic data transaction processing using gating criteria are described, including receiving data associated with an order, retrieving other data associated with one or more resources configured to fulfill the order, using the other data and one or more gating criteria to generate a determination to dynamically allocate the data associated with the order, and dynamically allocating the data to one or more of a plurality of services using the determination.

### CROSS-REFERENCE TO RELATED APPLICATIONS

This application claims the benefit of U.S. Provisional Patent Application No. 61/452,066 filed Mar. 11, 2011, and is also a continuation-ill-part of U.S. patent application Ser. No. 13/219,480 filed Aug. 26, 2011, which claims the benefit of U.S. Provisional Patent Application No. 61/452,066 filed Mar. 11, 2011 and U.S. Provisional Patent Application No. 61/377,438 filed Aug. 26, 2010, all of which are herein incorporated by reference for all purposes.

### FIELD

The present invention relates generally to software and data processing. More specifically, techniques relating to dynamic data transaction processing using gating criteria are described.

### BACKGROUND

Many conventional goods and services providers use electronic order and fulfillment systems that are typically implemented using various end user hardware and software, which may be client, server, or cloud (i.e., network)-based. Receiving data indicating orders, providing shipment or delivery information, coordinating supply chain or manufacturing orders, and other purposes typically rely upon the exchange of data between providers, vendors, manufacturers, wholesalers, retailers, and consumers. However, resource management is a continuous and constant challenge to ensure that orders are not only fulfilled timely and in accordance with customer requirements, but also to the limit or extent of resources available to a given business. Using conventional solutions, businesses, individuals, sole proprietors, and other concerns are challenged to manage resources and orders to deliver goods or services based on available resources using limited application functionality and contending with problematic, inaccurate, and expensive performance.

Some conventional solutions allow for electronic, networked, or online input and receipt of order information. This information is often transmitted into a database where it may be retrieved, manually or automatically, to a conventional software, hardware, or combined system that uses the data to produce or manufacture the ordered good or services. However, conventional solutions do not adjust for the limitation or allowance of orders based on real-time management of resources available to a given manufacturer. Instead, many conventional solutions allow for the manual or systemic-input of a threshold, above which orders are declined or rejected altogether. Until the thresholds are adjusted, either manually or automatically, conventional solutions are likely to continue declining or rejecting orders, which can be detrimental to a business when resources become available again.

As a conventional example, a restaurant or food service provider that receives orders online often seeks to maximize its daily production of meals by preparing and selling them based on available resources it has in stock. However, allowing for the online entry of orders using conventional solutions does not take into account limitations for a particular item that could restrict the quantity of a specific dish. Further, using conventional solutions, orders may be received without restriction, which could result in untimely delivery (e.g., substantial delays while waiting for a given order to be prepared) if a large number of orders are delivered or available supply of an ordered item or component thereof (e.g., a given ingredient) become unavailable or are consumed entirely. Further, the specification of a threshold could result, using conventional solutions, in curtailing orders and, subsequently, revenue and income by declining or rejecting the acceptance of new orders despite having sufficient resources available to fulfill the requested item(s). Still further, using conventional solutions, significant expense is incurred by hiring employees or other individuals who have sufficient training to managing conventional solutions in order to more accurately adjust to changing materiel and resources on a more dynamic or near real-time basis. However, due to the many disparate needs between businesses, including those in the same industry, conventional solutions generally do not provide features or functionality that allows for tailored consideration of business factors and data.

Thus, what is needed is a solution for managing transaction data and production of finished goods or services using automated systems without the limitations of conventional techniques.

### BRIEF DESCRIPTION OF THE DRAWINGS

The present invention will be readily understood by the following detailed description in conjunction with the accompanying drawings. Like reference numerals designate like structural elements. Although the drawings depict various examples of the invention, the invention is not limited by the depicted examples.

FIG. 1A illustrates an exemplary dynamic data transaction processing using gating criteria architecture;

FIG. 1B illustrates another exemplary dynamic data transaction processing using gating criteria architecture;

FIG. 1C is an exemplary services architecture for dynamic data transaction processing using gating criteria

FIG. 2 illustrates an exemplary domain model for dynamic data transaction processing using gating criteria;

FIG. 3A illustrates an exemplary dynamic data transaction processing using gating criteria system;

FIG. 3B illustrates another exemplary dynamic data transaction processing using gating criteria system;

FIG. 4 illustrates an exemplary environment input architecture;

FIG. 5A is an exemplary data flow diagram for dynamic data transaction processing using gating criteria system;

FIG. 5B is another exemplary data flow diagram for dynamic data transaction processing using gating criteria system;

FIG. 5C is a further exemplary data flow diagram for dynamic data transaction processing using gating criteria system;

FIG. 5D is yet another exemplary data flow diagram for dynamic data transaction processing using gating criteria system;

FIG. 5E is another exemplary data flow diagram for dynamic data transaction processing using gating criteria system;

FIG. 5F is a further exemplary data flow diagram for dynamic data transaction processing using gating criteria system;

FIG. 5G is still a further exemplary data flow diagram for dynamic data transaction processing using gating criteria system;

FIG. 6 illustrates an exemplary process for dynamic data transaction processing using gating criteria;

FIG. 7 illustrates another exemplary process for dynamic data transaction processing using gating criteria; and

FIG. 8A shows an exemplary interface for dynamic data transaction processing using gating criteria;

FIG. 8B shows another exemplary interface for dynamic data transaction processing using gating criteria;

FIG. 8C shows an alternative exemplary interface for dynamic data transaction processing using gating criteria;

FIG. 8D shows a further exemplary interface for dynamic data transaction processing using gating criteria;

FIG. 8E shows yet another exemplary interface for dynamic data transaction processing using gating criteria;

FIG. 8F shows another alternative exemplary interface for dynamic data transaction processing using gating criteria;

FIG. 8G shows a further alternative exemplary interface for dynamic data transaction processing using gating criteria;

FIG. 8H shows an exemplary vendor interface for dynamic data transaction processing using gating criteria;

FIG. 8I shows another exemplary vendor interface for dynamic data transaction processing using gating criteria;

FIG. 8J shows an alternative exemplary vendor interface for dynamic data transaction processing using gating criteria;

FIG. 8K shows a further exemplary vendor interface for dynamic data transaction processing using gating criteria;

FIG. 8L shows yet another exemplary vendor interface for dynamic data transaction processing using gating criteria;

FIG. 8M shows another alternative exemplary vendor interface for dynamic data transaction processing using gating criteria;

FIG. 8N shows an another exemplary vendor interface for dynamic data transaction processing using gating criteria;

FIG. 8O shows yet a further exemplary vendor interface for dynamic data transaction processing using gating criteria;

FIG. 8P shows a further alternative exemplary vendor interface for dynamic data transaction processing using gating criteria; and

FIG. 9 illustrates an exemplary computer system suitable for dynamic data transaction processing using gating criteria.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the techniques described may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof for purposes of providing computational and processing capabilities. If implemented as software, the described techniques may be implemented using various types of programming, development, scripting, or formatting languages, frameworks, syntax, applications, protocols, objects, or techniques, including C, Objective C, C++, C#, Adobe® Integrated Runtime™ (Adobe® AIR™), ActionScript™, Flex™, Lingo™, Java™, Javascript™, JSON (JavaScript Object Notation), Ajax, Perl, COBOL, Fortran, ADA, XML, MXML, HTML, DHTML, XHTML, HTTP, XMPP, JSON and others. Design, publishing, and other types of applications, such as Dreamweaver®, Shockwave®, Flash®, and Fireworks®, may also be used to implement the described techniques. The described techniques may be varied and are not limited to the examples or descriptions provided.

Techniques for dynamic data transaction processing using gating criteria enable a software-based system used by a business, individual, entity, enterprise, or other type of concern to customize, adjust, modify, or otherwise manage a self-maintaining order processing system based on gating criteria (e.g., criteria, factors, input, or other data input by a user of the techniques described in order to dynamically allocate data associated with an order among one or more services (e.g., web services, catalog services, or other network-based service configured to serve one or more applications, functions, features, or other processes)). In some examples, a type of industry that may employ the described techniques includes any type of business, including food vendors employing assets such as a mobile food truck or other good or service vendor (i.e., “business”) that relies upon the delivery of goods or services from a remote or variable (i.e., mobile) location. Gating criteria may be any type of criteria that are used to provide qualitative or quantitative factors or inputs that are subjected to logic-based systems and algorithms that are used to convert (i.e., transform) the inputs into data that may be used to manage or control output relative to various factors (e.g., the vendor's geographic location, opening times, inventory levels, environmental limitations, resource availability, order limits, business operating parameters (e.g., operating hours, order amount limitations (e.g., currency value of a single order, currency value of multiple orders input by a single customer, and the like), and others) or to a business' preferences (e.g., promotions, partners, nearby events, and the like)). Here, the gated and automated order processing techniques described in further detail below allow vendors to manually, semi-automatically, or automatically control the flow (e.g. timing, volume and other factors) of incoming orders according to one or more factors by designating gating criteria for order placement. Using gating criteria, orders can be dynamically managed in a real-time or near real-time basis to control, for example, the number of orders accepted in a given period of time relative to a given business' capacity to produce goods. In other words, gating criteria may be used to dynamically control, at a given time interval relative to received orders, output conditions (e.g., production capacity, promotions, limit to capacity, including taking into account such factors as the planned volume of orders a vendor fulfills during a given time slot, a vendor's inventory levels, an amount of time for a vendor to prepare or service an item, environmental factors that may determine whether a vendor can service customers at a given location and time, and promotions, among other factors. In some examples, the gated and automated order processing techniques described in more detail below also allow vendors to dynamically and automatically vary prices, fees, or gating criteria (e.g., order volume limit for a time slot) based upon fluctuating demand and environmental factors. In other examples, techniques for gated and automated order processing may be implemented differently than as described herein.

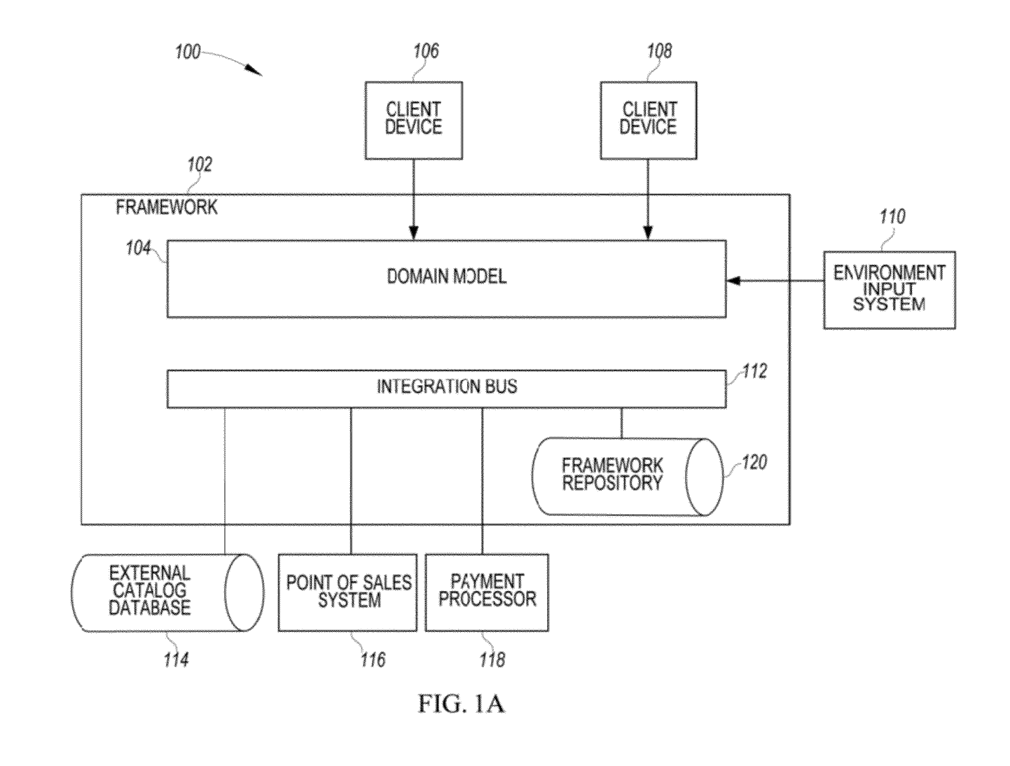

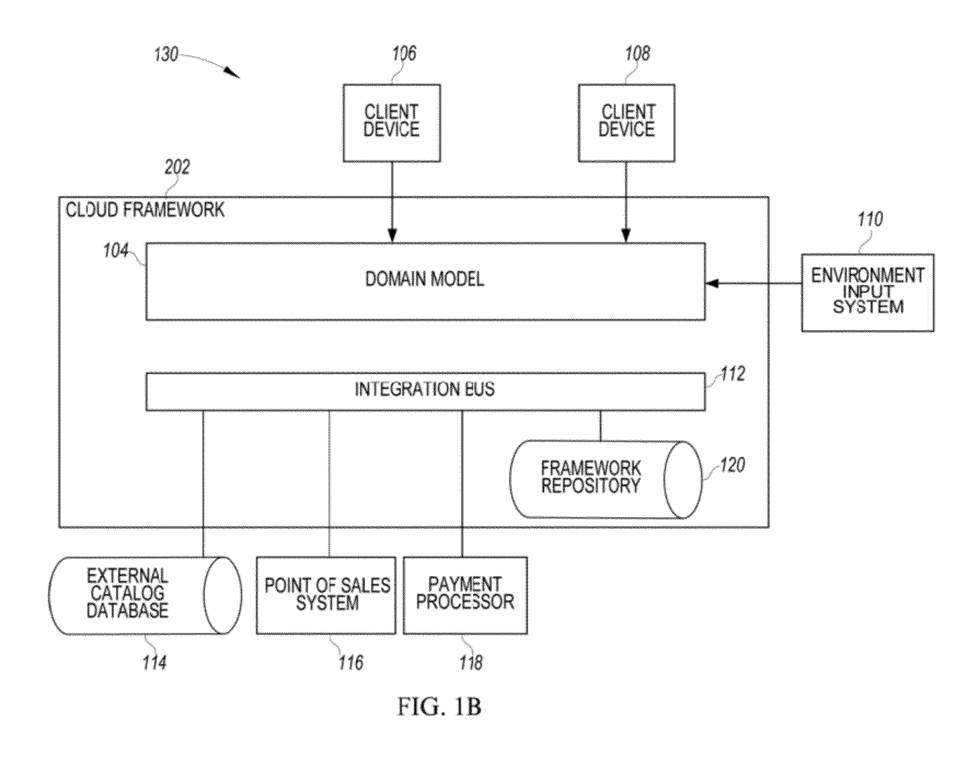

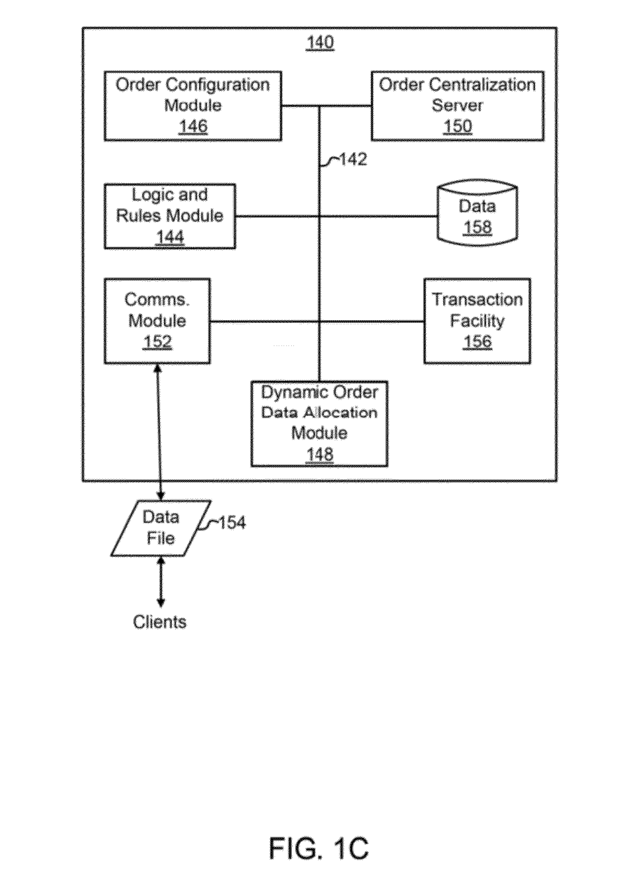

FIG. 1A illustrates an exemplary dynamic data transaction processing using gating criteria architecture. In some examples, gated and automated order processing architecture 100 can include a framework 102, a domain model 104, client devices 106 and 108, an environment input 110, an integration bus 112, an external catalog database 114, a point of sales system 116, a payment processor 118, and framework repository 120. The number, type, configuration, and other aspects of gated and automated order processing system 100 illustrated here may be varied without limitation to the examples shown or described here. For example, point of sales system 116 and payment processor 118 may be implemented to reside in one or more systems. In other examples, framework repository 120 may be implemented to reside outside of framework 102.

FIG. 1B illustrates another exemplary dynamic data transaction processing using gating criteria architecture. In some examples, gated and automated order processing architecture 130 can include cloud framework 202. Cloud framework 202 may be implemented on a cloud computing platform. As described herein, any variations or implementations discussed in relation to architecture 100 and framework 102 may be applied to architecture 130 and cloud framework 202, respectively, and vice versa.

As shown in FIG. 1A, framework 102 may comprise domain model 104, integration bus 112, and framework repository 120. Domain model 104 provides the conceptual representation of the component functionalities that may be included in framework 102. Framework repository 120 may be implemented to store data associated with gated and automated order processing architecture 100. Although framework repository 120 is depicted as within framework 102, as with any repository or data storage, it may be implemented partially or completely as a remote or local storage facility. Framework repository 120 may be implemented as a single, multiple-instance, standalone, distributed, or other type of data storage facility. Framework repository 120 also may be implemented to function as generalized storage, or provide a cache to framework 102.

The integration bus 112 allows the cloud framework 102 to communicate or interact with external systems, e.g. external catalog database 114, point of sales system 116, or payment processor 118, as well as other sub-systems, e.g. framework repository 120, which may or may not be external to cloud framework 102. The external catalog database 114 can provide to framework 102 items (i.e., goods or services) available to order. The integration bus 112 may be adapted to support interactions with various implementations of each type of external system. For example, the point of sales system 116 can be a physical “checkout” system, such as a cash register or checkout kiosk, or it can be a an e-commerce or online (i.e., web-based) “checkout” system. In another example, the payment processor 118 can be configured to accept specific types of payment (e.g., credit or debit cards, Paypal®, bank withdrawals, etc.). In some examples, the external systems may be developed or maintained by a vendor or a third party.

As shown in FIG. 1B, cloud framework 202 also may comprise domain model 104, integration bus 112, and framework repository 120. As described herein, domain model 104, integration bus 112, and framework repository 120, each may be implemented in the same manner as in framework 102, as well as with the same variations.

In some examples, architecture 100 and architecture 130 may be configured for use with one or more applications, some of which may be written (i.e., developed) using native or other programming and formatting languages, protocols, and specifications, such as those described above. As used herein systems may be implemented using any type of computing device, hardware, software, firmware, circuitry, or a combination thereof. For example, any of the sub-systems shown here, or any other sub-systems not shown that may communicate or interact with any of the sub-systems shown here, may be provided by third parties or developed natively (i.e., specifically for an implementation of architecture 100 or architecture 200) and may be implemented, for example, using a software development kit (SDK) or using an application programming interface (API) supplied by a third party. For example, an external catalog database, point of sales system, payment processor, framework repository, or other device (as used herein, “device” and “client device” may be used interchangeably) interfaces may be third party applications that provide features or functionality to framework 102 or cloud framework 102.

FIG. 1C is an exemplary services architecture for dynamic data transaction processing using gating criteria. Here, system 140 includes data bus (i.e., “bus”) 142, logic and rules module 144, order configuration module 146, dynamic order data allocation module 148, order centralization module 150, communications module 152, JSON data file 154, transaction facility 156, and data repository (e.g., database, memory, storage, storage area network (“SAN”), storage facility, storage server, and the like) 158. As shown bus 142 may be configured to transfer data between one or more of elements 144-158, which may be configured differently using topologies or network configurations apart from those shown and described, without limitation. Further, the number and type of elements 142-158 may be varied and are not limited to the specific configuration or functions described. For example, one or more servers, applications, processes, services (e.g., web services), catalogs, or other elements or components may be used to perform any of the functions described in system 140. As a further example, one or more of the processes associated with elements 142-158 may be performed on a single computer, server, networked processing/processor facility, or may be distributed across one or multiple processing elements, again, without limitation to the configuration shown.

In some examples, logic and rules module 144 may be configured to receive user or system input (including adaptive learning or adaptive rules generation) for any rules, parameters, or processing criteria that may be used to process data transactions (e.g., orders, purchase transactions, commercial transactions, payment transactions, and others) as described herein. Order configuration module 146 may be implemented as a service catalog that includes rules or information for a given business. For example, a mobile food or restaurant business can use order configuration module 146 to describe general parameters associated with pricing, menu items, hours of operation, location (for mobile food vendors (e.g., mobile food trucks, and the like)), and other information. In some examples, dynamic order data allocation module 148 receives input (e.g., an order in the form of data file 154 (which may be formatted or generated using any type of data encapsulation techniques, such as scripting or other programming languages (e.g., Java, JSON, and others))) from clients and, using input from logic and rules module 144 and order configuration module 146, dynamically determines how to allocate the order for efficient fulfillment, taking into account various factors and gating criteria such as an assigned time value associated with an order intended for delivery or pickup at a given time, available resources, available facilities (e.g., a large food order placed in a professional, amateur, high school, recreational, or other type of sports venue such as a ballpark, football stadium, hockey rink, or the like, which may have multiple kitchens or concessions stands that each provide a “delivery point” at which food can be picked up or delivered to a given location (e.g., a specific row/seat) by a runner or delivery person; likewise a pizza delivery business may have several disparate locations in close proximity to a given customer and may be able to “pool” resources to complete a larger order for consolidation at one location prior to being delivered), and the like. In other words, a quantitative value may be assigned to a given order based on when the order is received, when it is intended for delivery, pickup (i.e., fulfillment), and, algorithmically determine how to complete the order. By taking into account dynamically-changing conditions and data associated with a given good or service provider, dynamic order data allocation module 148 can modify the fulfillment conditions (e.g., location, facility, resource, personnel, and the like) that are used to complete an order in a timely, efficient manner. Thus, inefficiencies such as unused resources (e.g., a kitchen and its staff are busy while another sits idle; a mobile food vendor's truck in one location is busy while another nearby vehicle sits idly by awaiting an order)) can be minimized using the described techniques in the form of an application that is used to transfer data (e.g., JSON-formatted data files (e.g., data file 154)) to a client-side application being used on a native device such as a smart phone or specially-configured device (e.g., credit card terminal, cash register, near-field communication (“NFC”) receiver coupled to or in data communication with a mobile or hand-held smart phone or computing device of any type, without limitation, apart from the installation of a client-side application configured to communication with system 140.

In some examples, and as described in some above, order centralization server 150 may be used to consolidate goods or services intended to be provided in response to a given order. In conjunction with dynamic order data allocation module 148, order centralization server 150 may be configured to generate data included in data file 154 for transfer to a client device, terminal, or other endpoint configured to provide information to personnel prepared to complete a given order. Further, communications module 152 may be configured to communicate using any type of data communication protocol(s) for wired or wireless communication between system 140 and clients, the latter of which may include any type of computing device configured to communicated with system 140. Further, communications module 152 may be configured to format, receive, interpret, parse, translate, or otherwise process any incoming or outbound data files (e.g., data file 154). Transaction facility 156 may be a partial or full module that is configured to perform credit, debit, or other financial transactions in satisfaction of a given order. In some examples, transaction facility 156 may be an application, program, module, or other hardware, software, or combined hardware/software element that is configured to perform a given financial transaction. In other examples, transaction facility 156 may be an element, application, program, module, or other hardware, software, or combined hardware/software element that is configured to format and/or provide authentication or security features to encrypt, decrypt, authenticate, or otherwise transfer financial information such as credit card or banking account numbers to a credit card issuer, bank, the Federal Reserve, or other facility. For purposes of the description provided herein, transaction facility 156 may be implemented as part of system 140 or as a separate system that is configured to be in data communication with system 140. Further, database 158 may be any type of data repository or storage facility that is configured to store data received, processed, or transferred by system 140. In other examples, the function, configuration, quantity, or other aspects of system 140 and the elements shown may be varied and are not limited to those shown and described.

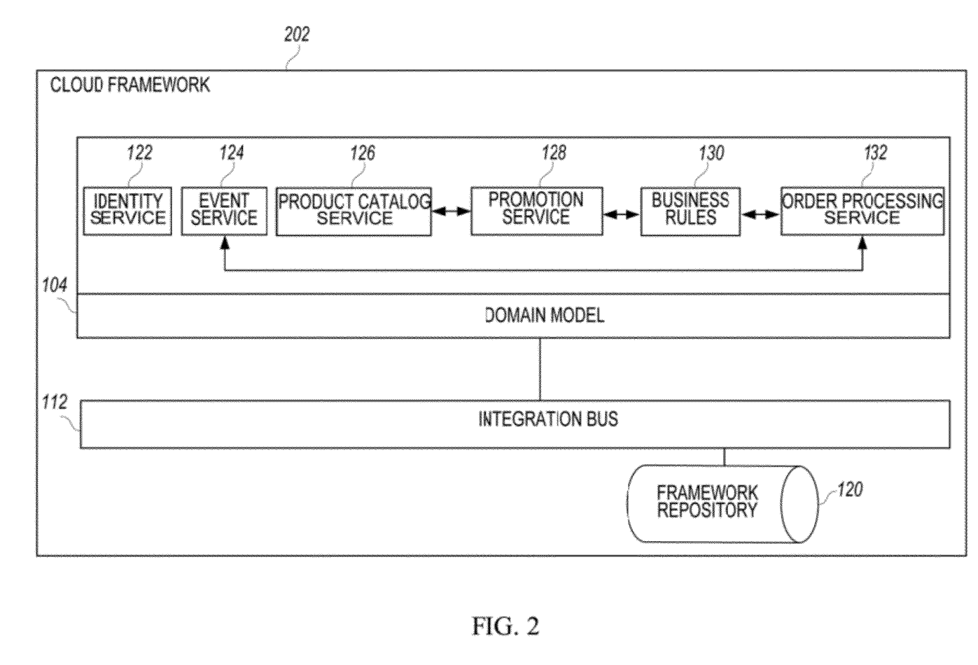

FIG. 2 illustrates an exemplary domain model for dynamic data transaction processing using gating criteria. Order processing service 132 may be implemented to manage orders received from client device 106 according to gating criteria and other input (e.g., from business rules 130 or event service 124). Order processing service 132 also may be implemented to manage gating criteria customizable by a vendor using client device 108. Vendor criteria may include a maximum number of orders with open status at any given time, a target number of orders for a given time period (e.g., a service period, a pick tip time, or other time periods), a maximum number of order slots for a pick up time, an active status of a pick up time, an active status of an order slot, and a value of an order slot. Order processing service 132 also may be implemented to provide data to client device 108 to solicit vendor criteria input from a vendor. In some examples, order processing service 132 may provide data to client device 106 to solicit orders from a customer. In other examples, order processing service 132 also may allow customers to make purchases or to save items for purchase.

As shown in FIG. 2, business rules 130 may be implemented to update order processing service 132 and promotion service 128. In some examples, business rules 130 may influence prices, availability, service charges, or discounts, relating to orders or items, using conditions and other input from promotion service 128, order processing service 132, or environment input 110. As described in more detail below, business rules 130 may include static or dynamic rules for manually, semi-automatically, or automatically adapt order processing to changing conditions.

In some examples, promotion service 128 may be implemented to recognize coupons or apply discounts based on various conditions. These conditions may be static (e.g., to the first hundred customers or to customers that input a promotional code) or dynamic (e.g., based upon fluctuations in demand, environmental factors, or other conditions). In some examples, promotion service 128 also may send advertisements to client device 106. Advertisements may be targeted based on a customer's location (including factors that may relate to that location, e.g., weather or special events) or purchase history. In some examples, advertisements from promotion service 128 may be pushed to customer client device 106.

In some examples, product catalog service 126 may be implemented to ensure that a customer is presented with a correct list of items available for purchase. Product catalog service 126 may do so by matching a customer's choice of vendor, or a determination of vendors available to a customer based on a customer's location, to one or more appropriate catalogs. Furthermore, if a vendor has multiple catalogs (e.g., a restaurant might have a lunch menu and a dinner menu) product catalog service 126 may be implemented to select the appropriate catalogs for a vendor based on time, date or other criteria. Optionally, once a catalog is identified, it may be saved on the local storage of a client device 106. In some examples, utilizing the local storage of client device 106 may reduce the amount of data that is required to be transferred from client device 106 through the network to cloud framework 202. For example, using the local storage of client device 106 might prevent the population surrounding a popular mobile food or service truck to over-tax a single cellular telephone tower servicing the area.

In some examples, event service 124 may be implemented to provide information relating to a nearby or on-location event with which a vendor may choose to associate. For example, event service 124 may provide information to order processing service 132 that is relevant to the vendor's offer of items for purchase (e.g., type of event, location of an event, date of an event, a start time for an event, an end time for an event, or other information).

Identity service 122 may be implemented to allow cloud framework 202 to recognize a client device (e.g., customer client device 106 or vendor client device 108). In some examples, identity service 122 may operate using traditional identifying information (e.g., name, address, credit card number, drivers license number, etc.). In other examples, for purposes of privacy and security, identity service 122 may be implemented to use other information to uniquely identify a client device (e.g., wireless device identifier (radio-frequency identification (RFID), other electronic tag communicated via near field communication (NFC), or Bluetooth) or secure login (e.g., username and password entry)). Identity service 122 also may be implemented to identify client device 106 for the purpose of verifying access privileges or vendor availability for a customer. Identity service 122 further may be implemented to identify client device 108 for the purpose of verifying access privileges for a vendor (e.g., to provide vendor criteria input or otherwise customize the operation of gated and automated order processing architecture 100).

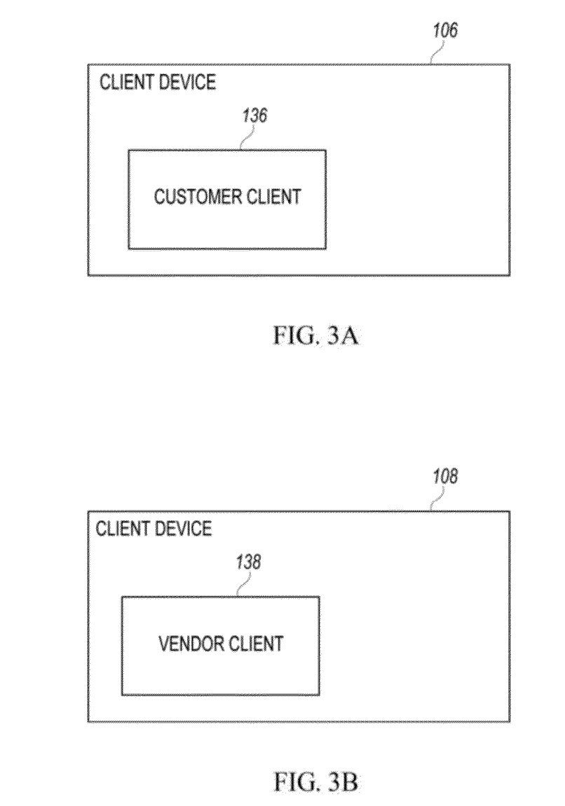

FIG. 3A illustrates an exemplary dynamic data transaction processing using gating criteria system. FIG. 3A depicts client device 106, which may comprise customer client 136. FIG. 3B illustrates another exemplary dynamic data transaction processing using gating criteria system

FIG. 3B depicts client device 108, which may comprises vendor client 138. In some examples, customer client 136 and vendor client 138 may be implemented as applications or systems that access a remote service on another computer system, e.g. a server, by way of a network. For example, customer client 136 and vendor client 138 may be implemented as “apps,” such as those used with the Apple iPhone® or the telephones running the Google Android® operating system. Client devices 106-108 each may also include a location sensor (i.e., global positioning system (GPS)), web-browsing capabilities, and local storage. In some examples, a local storage of client device 106 may be used to save data relating to vendors (e.g., catalogs) to minimize the amount of data that is required to be transferred to and from client device 106 through a network. Any number of data interchange formats (e.g., JSON, XML, or others) may be used for exchanging data between client devices 106-108 and a framework. In some examples, client devices 106 and 108 each may be a mobile device (e.g., smart telephone, laptop, tablet PC, automobile navigation system). In other examples, they may be a stationary device (e.g., kiosk). In some examples, data from a framework (e.g., advertisements or notifications) may be pushed to client devices 106-108.

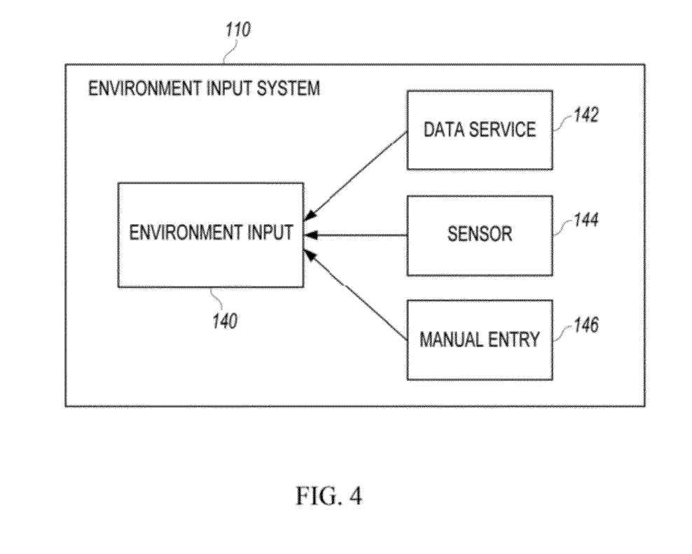

FIG. 4 illustrates an exemplary environment input architecture. FIG. 4 illustrates an exemplary environment input architecture 110 that may comprise environment input 140, data service 142, sensor 144, and manual entry 146. Data service 142 may be implemented to provide information from any number and type of available data services (e.g., weather feed or news feed). In some examples, sensor 144 may be a weather sensor or other type of sensor. In other examples, sensor 144 may be implemented as part of environment input architecture 110, or as a separate system in communication with environment input architecture 110 (e.g., through a network). In some examples, manual entry 146 may involve any number and type of available manual entry tools (e.g., keyboard, mouse, microphone, touchpad, or other manual input tool), either directly into environment input architecture 110 or using a separate system (e.g., a computer networked to environment input architecture 110). Environment input 140 may be implemented to gather information from data service 142, sensor 144, and manual entry 146. As described below, environment input 140 may be implemented to inform business rules 130 to influence updates relating to a promotion, service charge, or other aspects of order processing.

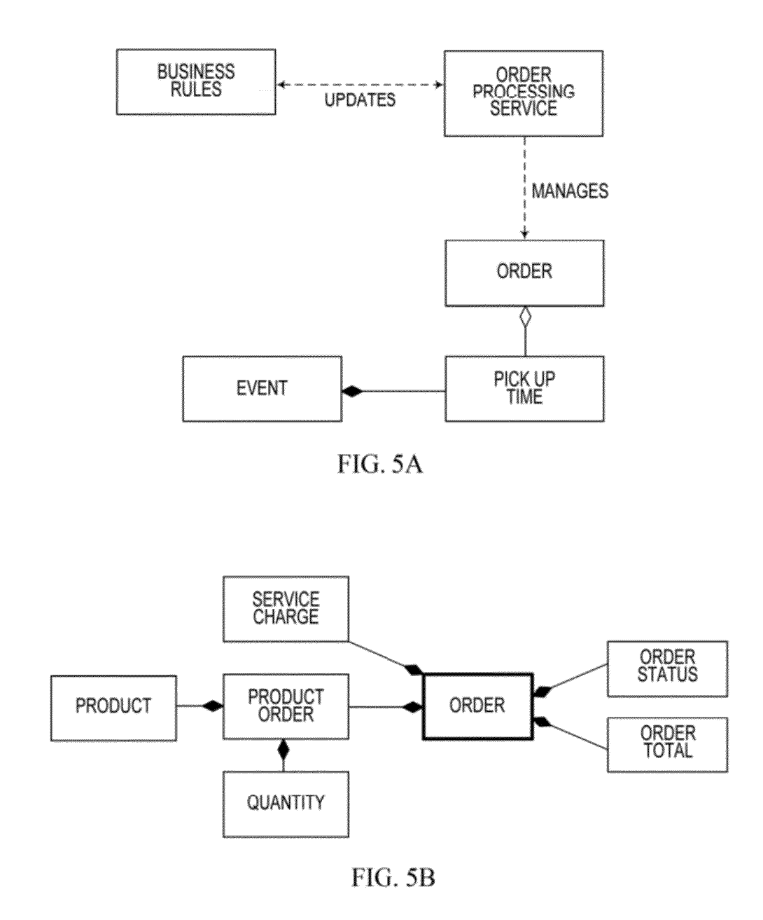

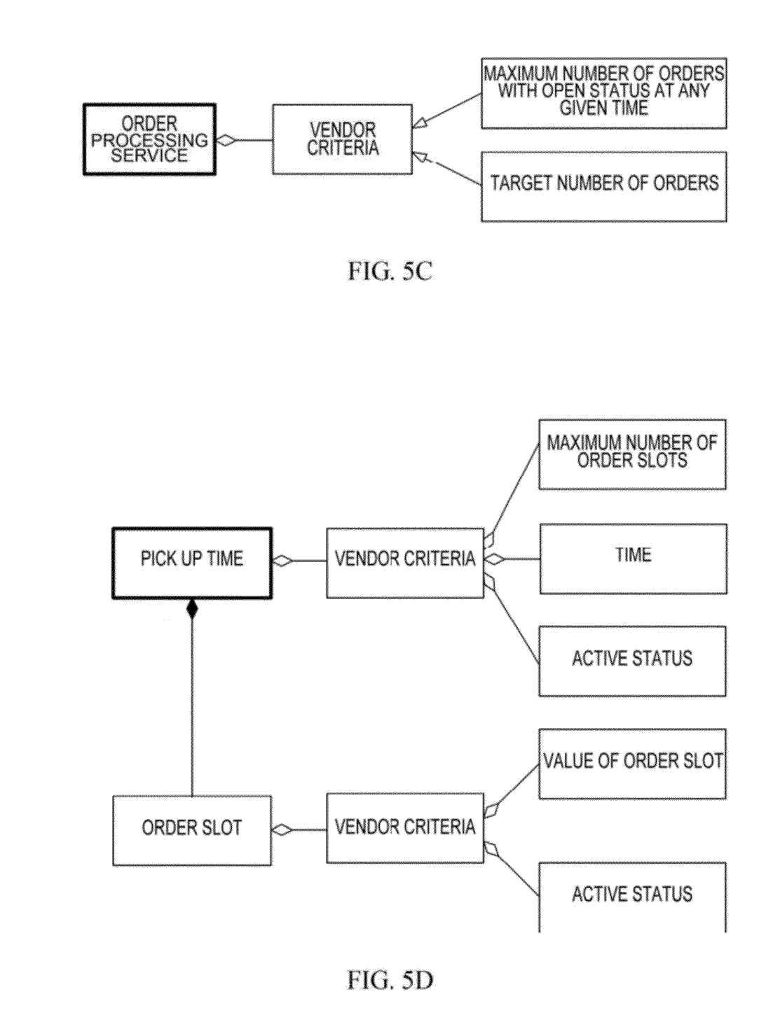

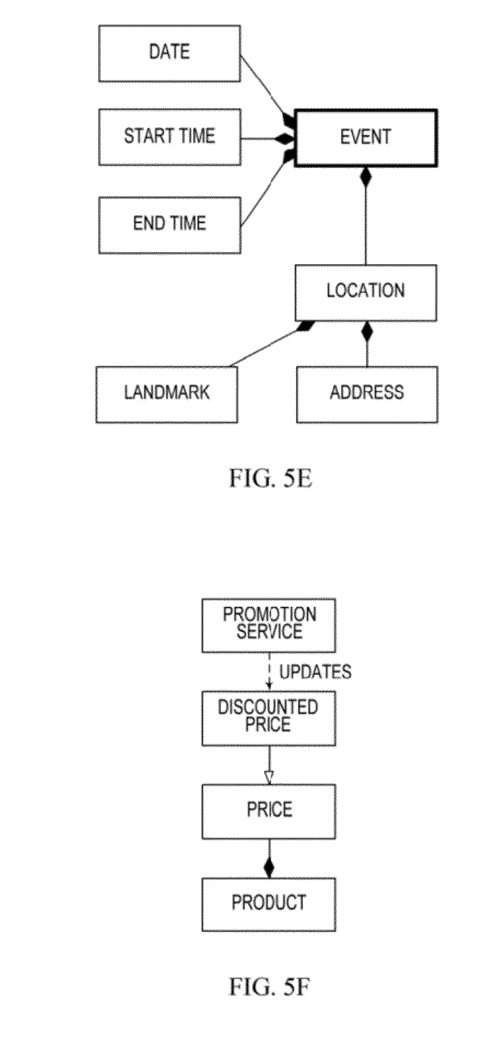

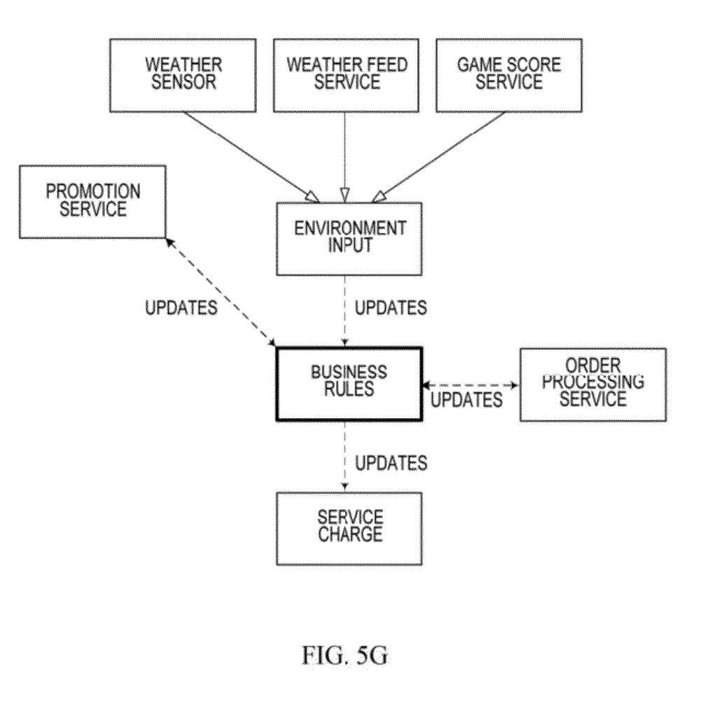

FIGS. 5A-5G are diagrams illustrating relationships between functionalities within, and in communication with, domain model 104. FIG. 5A is an exemplary data flow diagram for dynamic data transaction processing using gating criteria system. In some examples, FIG. 5A is a diagram that provides an overview of objects, which may be involved in providing the functionalities of a domain model for a gated and automated order processing architecture, and how they may be associated. As shown in FIG. 5A, an order processing service may be implemented to manage an order. An order processing service may receive updates from, and send updates to, a set of business rules. An order may be associated with a pick up time, and a pick up time, in turn, may be associated with an event.

FIG. 5B is another exemplary data flow diagram for dynamic data transaction processing using gating criteria system. In some examples, FIG. 5B is a diagram that illustrates additional objects that may be associated with an order in a gated and automated order processing architecture. As shown in FIG. 5B, an order may be associated with an order status, an order total, a service charge, and a product order. A product order, in turn, may be associated with a product (e.g., including information relating to a product ordered) and a quantity.

FIG. 5C is a further exemplary data flow diagram for dynamic data transaction processing using gating criteria system. FIG. 5D is yet another exemplary data flow diagram for dynamic data transaction processing using gating criteria system. In some examples, FIG. 5C and 5D are diagrams that illustrate additional objects that may be associated with an order processing service and a pick up time, respectively, in a gated and automated order processing architecture. As shown in FIGS. 5C and 5D, an order processing service and a pick up time may be associated further with vendor criteria. In some examples, a pick up time also may be associated with an order slot, which in turn may be associated with vendor criteria as well. Vendor criteria also may be used to gate orders by limiting a customer's access to vendors that are closed at the requested pick up time for any reason (e.g., the pick up time is outside of designated open times, weather does not permit the vendor to be open at that location), or access to order slots that are not available for any reason (e.g., the maximum number of order slots for that pick up time has been taken, the maximum value for that order slot has been taken). In some examples, vendor criteria associated with an order processing service may include a maximum number of orders with open status at any given time and a target number of orders for a time period. In other examples, vendor criteria associated with a pick up time may include a maximum number of order slots, a time, and an active status for a pick up time. In yet other examples, vendor criteria associated with an order slot may include a value of the order slot and an active status for the order slot. Vendor criteria may be specified or modified by a vendor at any time, after which gated and automated order processing architecture 100 will automatically gate orders according to the latest vendor criteria input.

FIG. 5E is another exemplary data flow diagram for dynamic data transaction processing using gating criteria system. In some examples, FIG. 5E is a diagram that illustrates additional objects that may be associated with an event in gated and automated order processing architecture 100. In some examples, an order may be gated according to conditions relating to an event with which a vendor may choose to associate. For example, a mobile food vendor may gate its order processing in accordance with a sporting event, or a schedule of sporting events. As shown in FIG. 5E, an event may be associated with a date, a start time, an end time, and a location. A location, in turn, may be associated with an address and a landmark.

FIG. 5F is a further exemplary data flow diagram for dynamic data transaction processing using gating criteria system. In some examples, FIG. 5F is a diagram that illustrates additional objects that may be associated with a product in gated and automated order processing architecture 100. As shown in FIG. 5F, an order may be gated according to conditions relating to a promotion. A product that is associated with a product order may have a price, and a price may be associated with a discounted price, which may be updated by a promotion service.

FIG. 5G is still a further exemplary data flow diagram for dynamic data transaction processing using gating criteria system. In some examples, FIG. 5G is a diagram that illustrates additional objects that may be associated with business rules in gated and automated order processing architecture 100. As shown in FIG. 5G, business rules and order processing service may be implemented to mutually update each other. In some examples, business rules and promotion service likewise may be implemented to mutually update each other. Updates provided by business rules may be obtained from environment input. Environment input may include various means for obtaining data relating to the environment (e.g., weather or status of nearby events), including a weather sensor, weather feed service and game score service. In some examples, environment input may include information regarding environmental conditions that influence the dynamic management of orders by order processing service. Business rules also may update a service charge with data received from environment input, order processing service or promotion service. Gated and automated order processing architecture 100 may be implemented using these interactions to dynamically adapt to changing conditions. For example, a service charge may be increased or decreased in accordance with order limit thresholds. In other examples, discounts or discounting schemes may be applied if a target order amount (i.e., total revenue or order count) is not achieved within a time period. In yet other examples, environmental conditions may be used to trigger promotions (e.g., a discount for a home team product triggered by a goal scored by the home team or a promotion for umbrellas or blankets triggered by inclement weather conditions). The number and type of objects that may be associated with any of the objects shown in FIGS. 5A-5G may be varied without limitation to the examples shown or described.

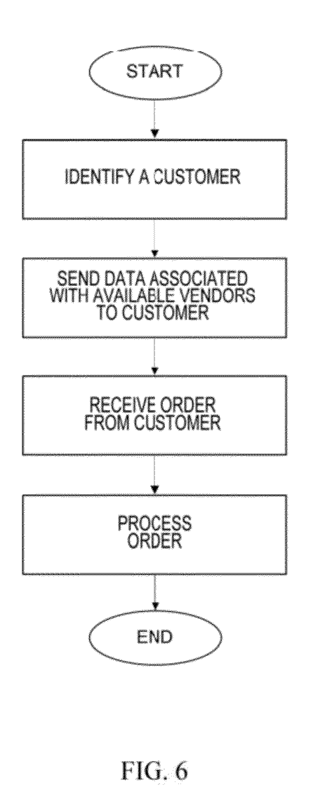

FIG. 6 illustrates an exemplary process for dynamic data transaction processing using gating criteria. Here, gated and automated order processing architecture 100 may identify a customer, send data vendors available to render services to a customer, receive an order from a customer, and process an order using one or more gating criteria. In some examples, identification of a customer may include detecting a customer's location. A customer may provide other identifying information that may inform architecture 100 whether a customer has previously accessed the system, made purchases from vendors available at a customer's current location, may have saved items for purchase from any of the available vendors, and more. In other examples, architecture 100 may allow a customer to proceed with browsing, or ordering, from a catalog without requiring uniquely identifying information (e.g., as a “guest”) outside of payment processing. In some examples, data sent to a customer may relate to catalogs (e.g., menus) of items offered for purchase by available vendors, information associated with the (un)availability of vendors, or any other information relating to vendors in or around a customer's identified location. In other examples, data sent to a customer also may relate to promotions available to a customer, offered by any vendors in or around a customer's identified location, and available either for current or future purchases. In some examples, data sent to the customer may be influenced by gating criteria, including vendor criteria (e.g., available pick up times), business rules applying environmental factors (e.g., increased or decreased service charges) or event conditions (e.g., start time and end time of an event). In some examples, architecture 100 applies gating criteria further during order processing.

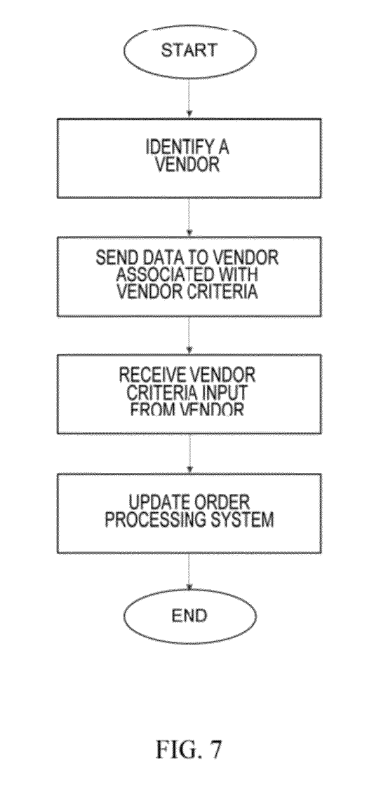

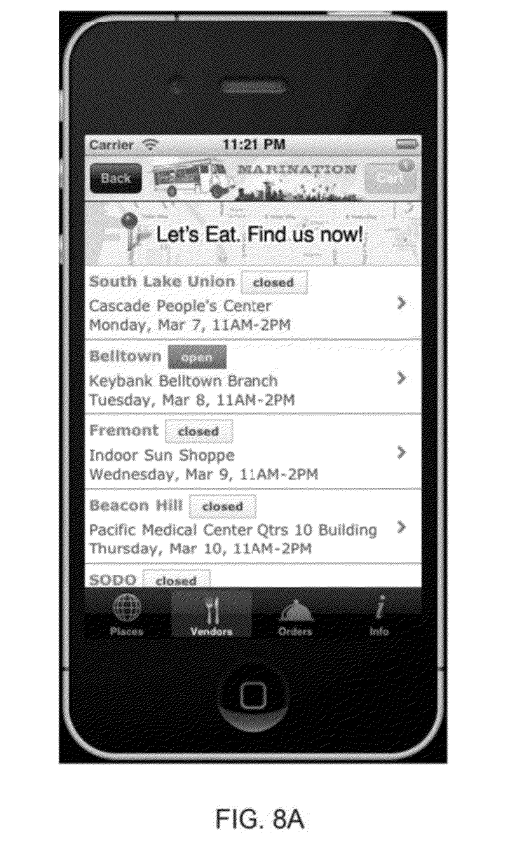

FIG. 7 illustrates another exemplary process for dynamic data transaction processing using gating criteria. Here, architecture 100 may identify a vendor, send data to a vendor regarding vendor criteria available for customization (e.g., specification or modification) by a vendor, receive input from a vendor associated with vendor criteria, and update an order processing service according to received vendor input. An identification of the vendor may include verification of access information. In some examples, data sent to a vendor providing options for customization of vendor criteria, as well as the manner in which input is provided by a vendor, may take on any number of structures or formats known in the art.

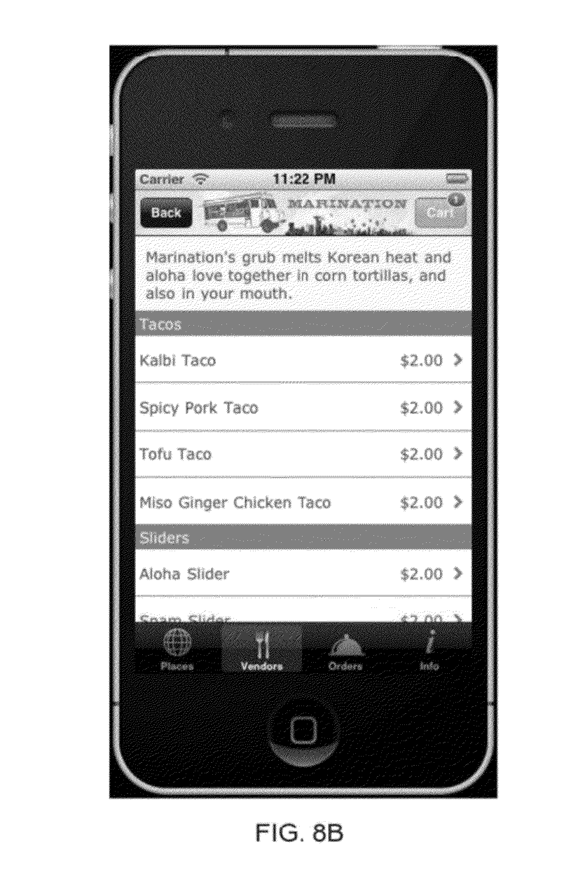

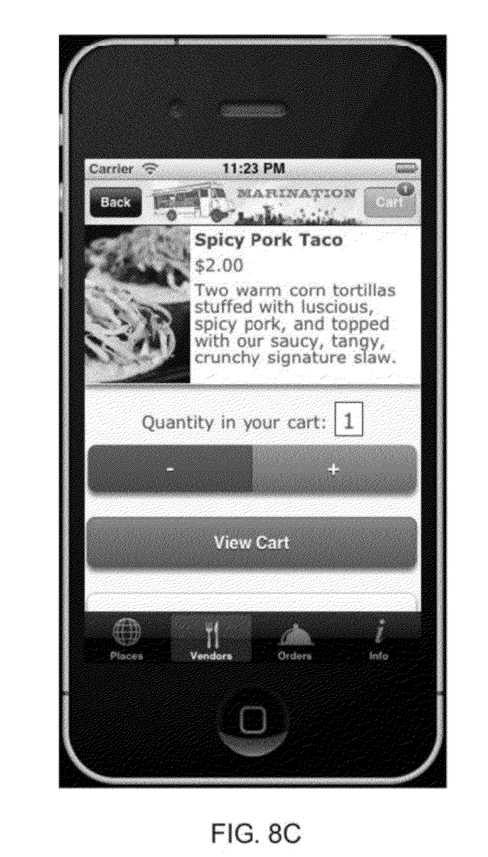

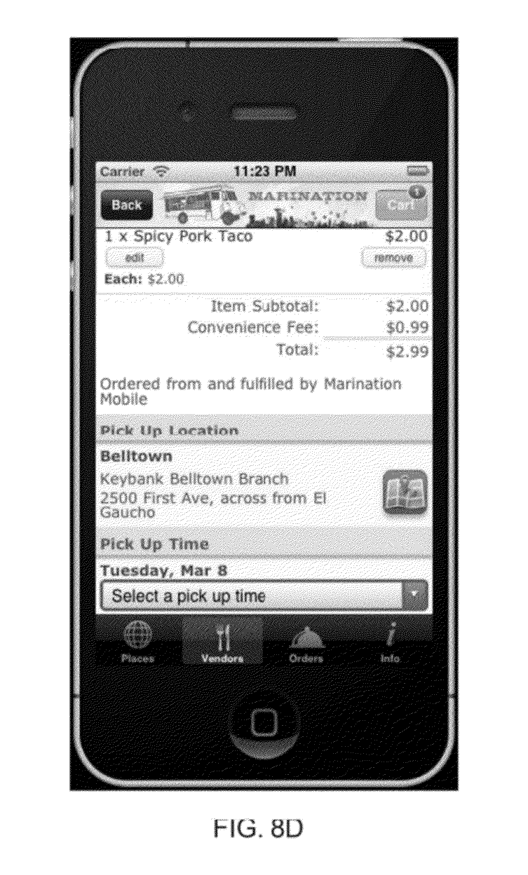

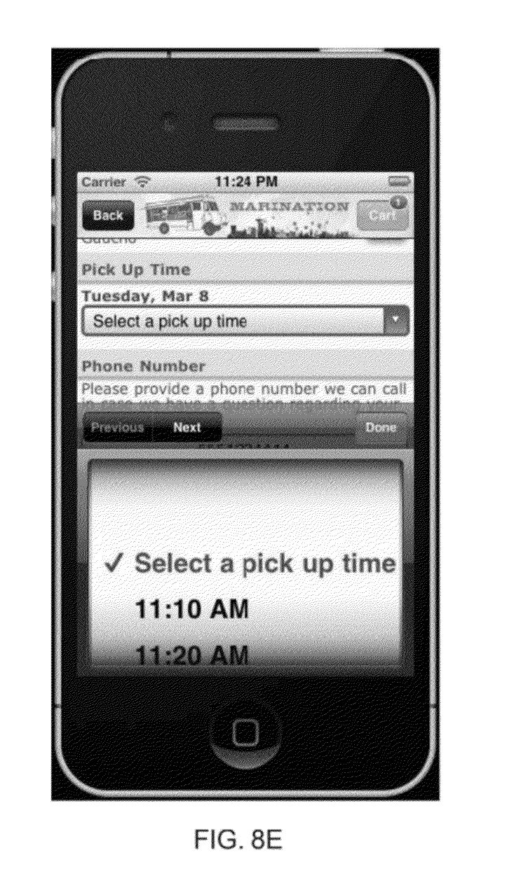

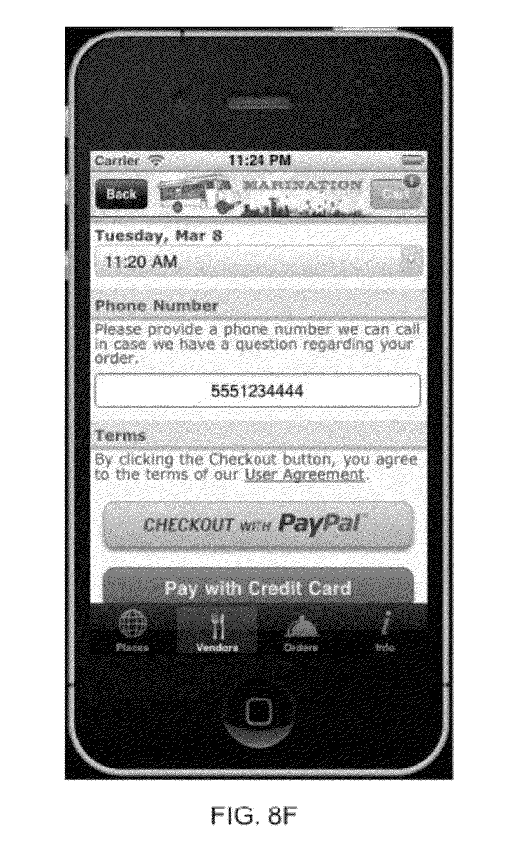

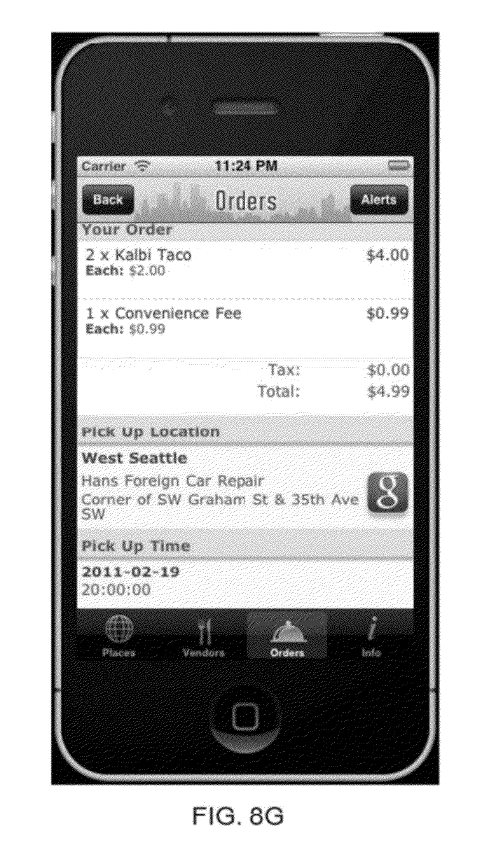

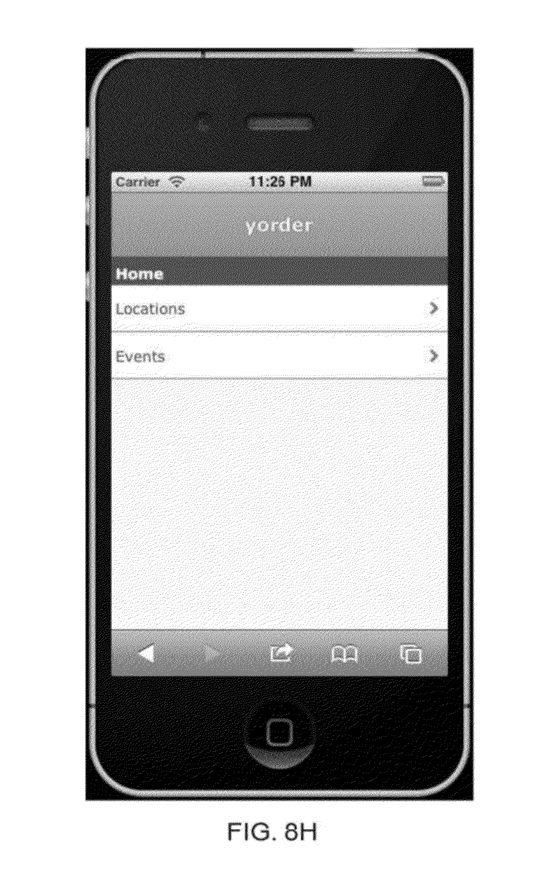

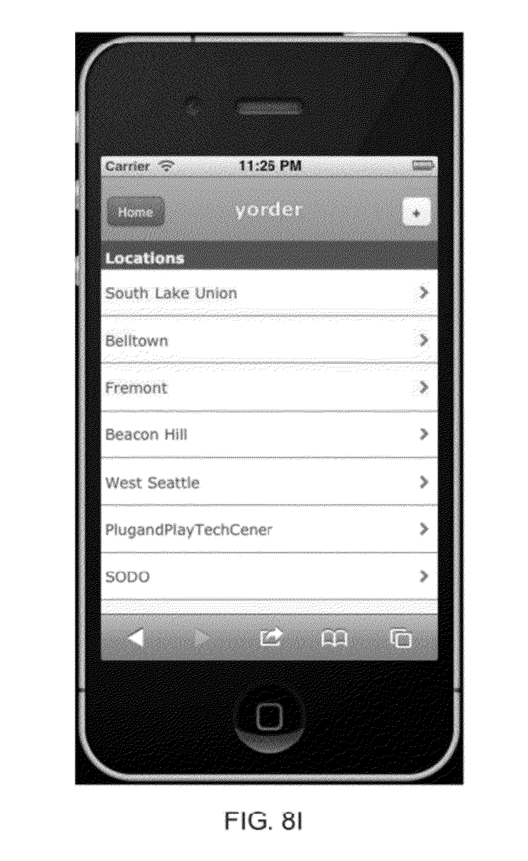

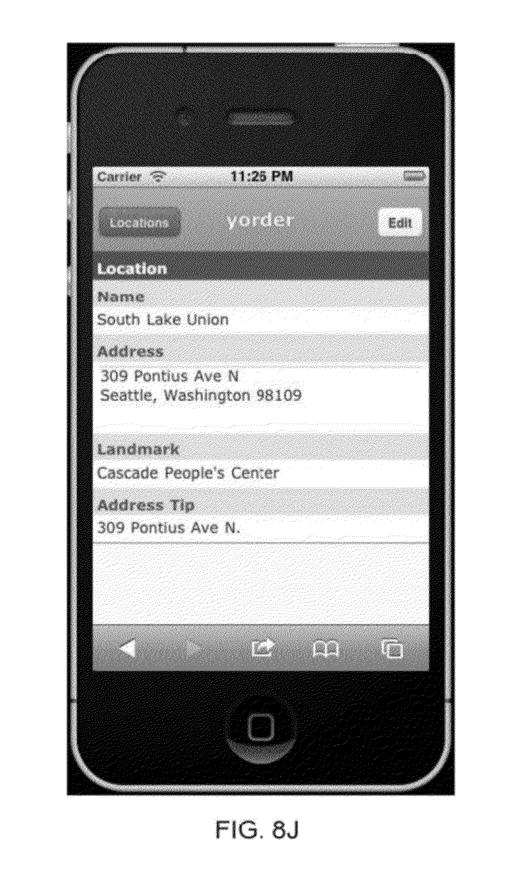

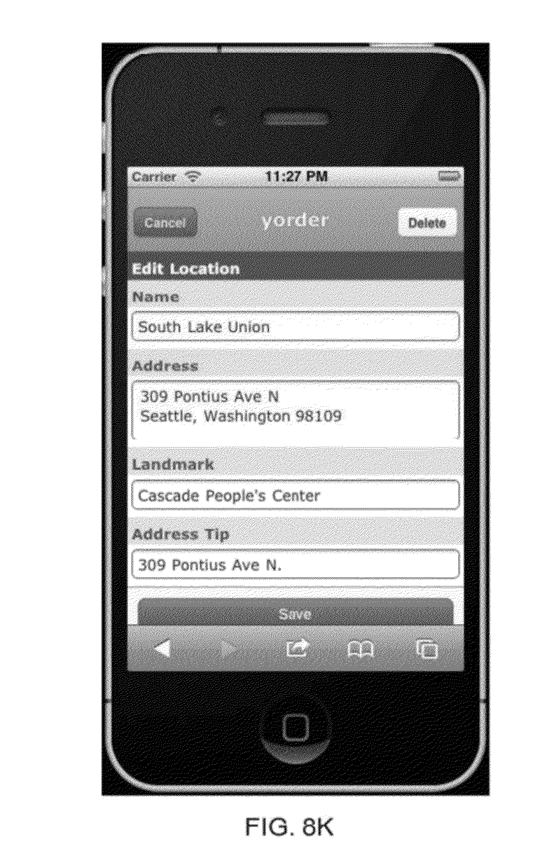

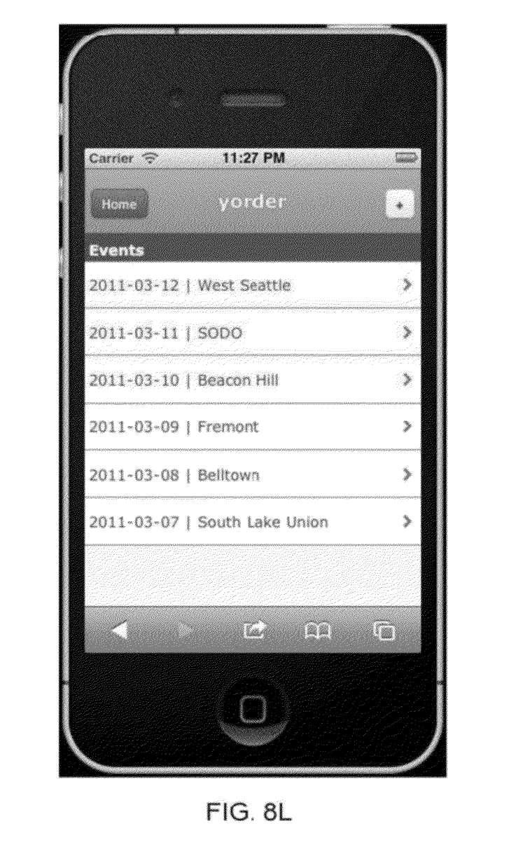

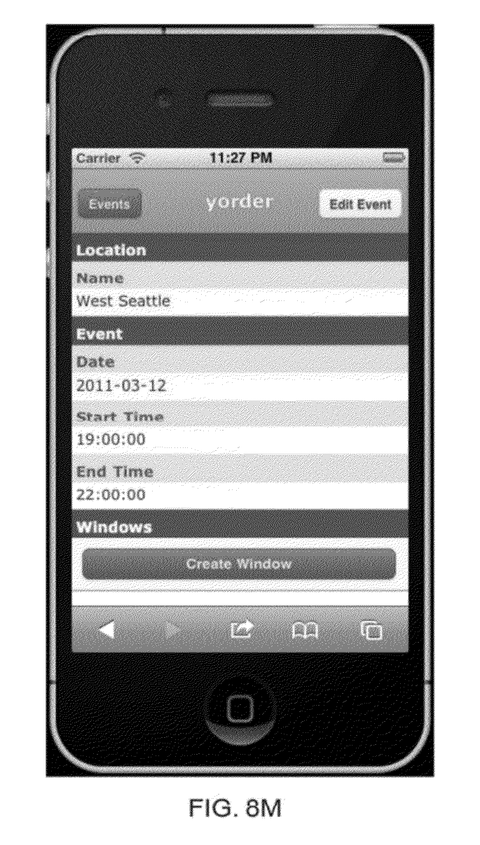

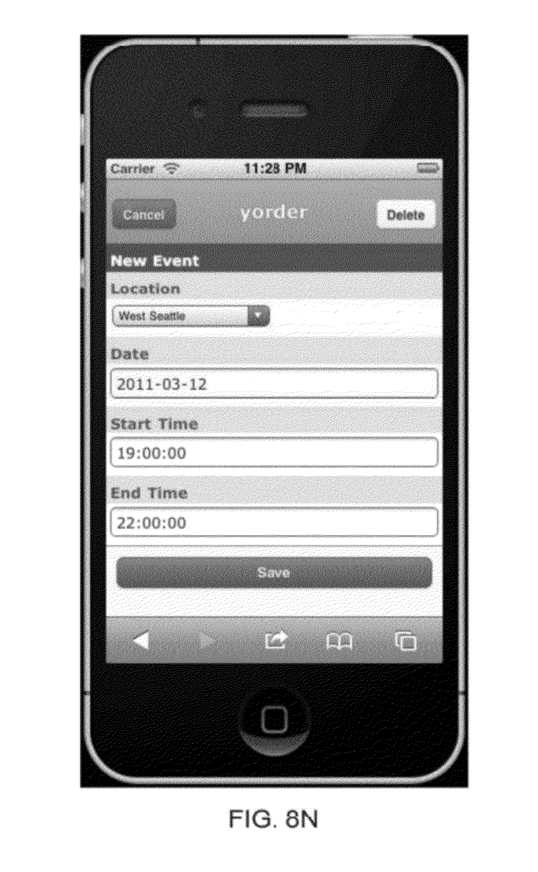

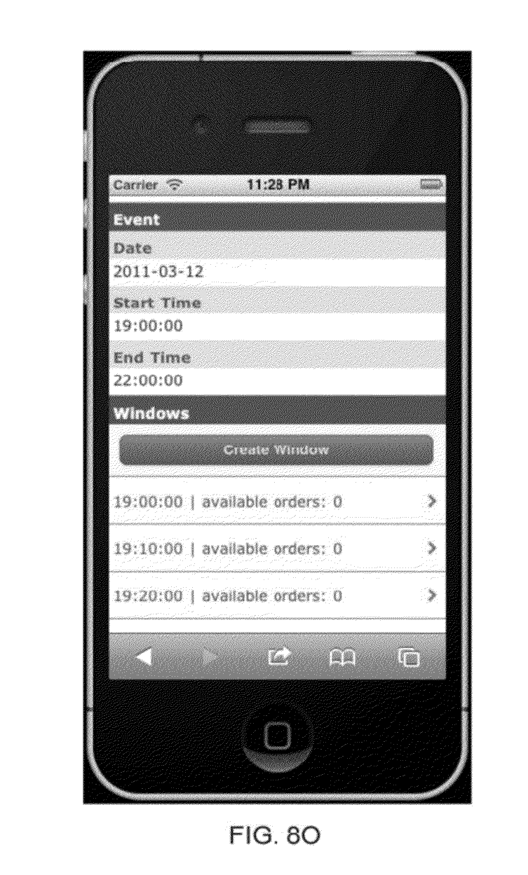

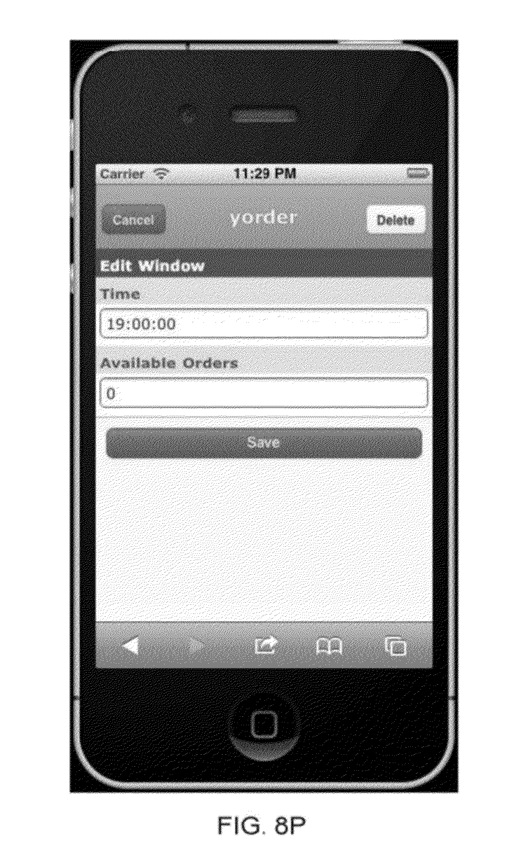

FIG. 8A illustrates an exemplary interface for dynamic data transaction processing using gating criteria. In some examples, after a user selects a vendor, the user is presented with a list of the vendor's locations for the current week. The location open for ordering has an open indicator. The vendor's location, date and time are displayed.

FIG. 8B illustrates another exemplary interface for dynamic data transaction processing using gating criteria. In some examples, after a user selects a vendor location that is open for ordering, the user is presented with a list of products that are available for ordering.

FIG. 8C illustrates an alternative exemplary interface for dynamic data transaction processing using gating criteria. In some examples, after a user selects a product from a menu, the user is presented with details relating to the product. The user can select to add the product to their cart. The user can then select to view the cart.

FIG. 8D illustrates a further exemplary interface for dynamic data transaction processing using gating criteria. In some examples, the cart displays the product quantities and order total for the products that the user has added. Also, the cart may prompt the user to select a pick up time for the order.

FIG. 8E illustrates yet another exemplary interface for dynamic data transaction processing using gating criteria. In some examples, pick up time options are presented to a user, and the user can select from available pick up times. If a time has no more open order slots, then the time will not be selectable. For example, as shown in FIG. 8E, the 11:00 pick up time is no longer available because it has zero available order slots, and therefore it is not shown as an available pick up time that the user may select.

FIG. 8F illustrates another alternative exemplary interface for dynamic data transaction processing using gating criteria. In some examples, when the user has selected a pick up time, the user can select to check out. If the pick up time has not been selected, the system may not allow the user to check out. For example, the system can hide the check out button, deactivate the check out button, or display an error message when the check out button is selected, to prevent the user from proceeding with check out.

FIG. 8G illustrates a further alternative exemplary interface for dynamic data transaction processing using gating criteria. When the check out is successful, the system can display an order summary to the user, which can include the pick up time selected by the user.

FIG. 8H illustrates an exemplary vendor interface for dynamic data transaction processing using gating criteria. In some examples, a vendor may be presented with a dashboard that allows for the creation of locations, events, and order slots.

FIG. 8I illustrates another exemplary vendor interface for dynamic data transaction processing using gating criteria. In some examples, a vendor can browse a list of existing locations. The vendor can select an action to create new locations as needed.

FIG. 8J illustrates an alternative exemplary vendor interface for dynamic data transaction processing using gating criteria. In some examples, a vendor may be presented with a screen that allows the vendor to provide, for each location, a name of the location, an address, a landmark (i.e., associated with the location), and an address tip.

FIG. 8K illustrates a further exemplary vendor interface for dynamic data transaction processing using gating criteria. In some examples, any of the location details supplied by the vendor can be edited as desired.

FIG. 8L illustrates yet another exemplary vendor interface for dynamic data transaction processing using gating criteria. In some examples, a vendor can browse a list of existing events. A vendor also may select an action to create new events as desired.

FIG. 8M illustrates another alternative exemplary vendor interface for dynamic data transaction processing using gating criteria. In some examples, a vendor may provide, for each event, a name of the event, a date of the event, a start time, and an end time.

FIG. 8N illustrates an another exemplary vendor interface for dynamic data transaction processing using gating criteria. In some examples, any of the event details supplied by the vendor can be edited as desired.

FIG. 8O illustrates yet a further exemplary vendor interface for dynamic data transaction processing using gating criteria. In some examples, a vendor can browse a list of existing order slots for an event. The vendor can select an action to create new order slots as desired.

FIG. 8P illustrates a further alternative exemplary vendor interface for dynamic data transaction processing using gating criteria. In some examples, a vendor may provide, for each order slot, a time and number of available orders. The vendor can change the time and available orders as desired. When the available orders is equal to zero, the order slot will not be displayed to users for selection.

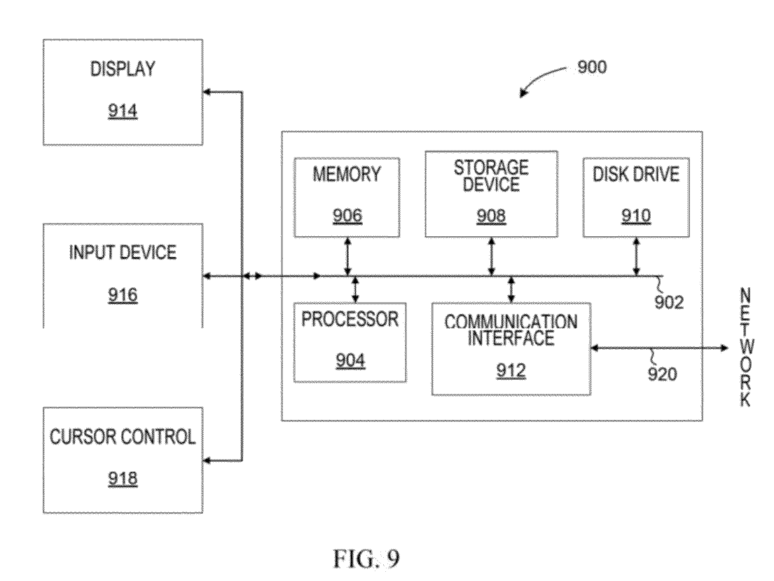

FIG. 9 illustrates an exemplary computer system suitable for automated data transaction processing using gating filters. In some examples, computer system 900 may be used to implement computer programs, applications, methods, processes, or other software to perform the above-described techniques. Computer system 900 includes a bus 902 or other communication mechanism for communicating information, which interconnects subsystems and devices, such as processor 904, system memory 906 (e.g., RAM), storage device 908 (e.g., ROM), disk drive 910 (e.g., magnetic or optical), communication interface 912 (e.g., modem or Ethernet card), display 914 (e.g., CRT or LCD), input device 916 (e.g., keyboard), and cursor control 918 (e.g., mouse or trackball).

According to some examples, computer system 900 performs specific operations by processor 904 executing one or more sequences of one or more instructions stored in system memory 906. Such instructions may be read into system memory 906 from another computer readable medium, such as static storage device 908 or disk drive 910. In some examples, hard-wired circuitry may be used in place of or in combination with software instructions for implementation.

The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks, such as disk drive 910. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by a single computer system 900. According to some examples, two or more computer systems 900 coupled by communication link 920 (e.g., LAN, PSTN, or wireless network) may perform the sequence of instructions in coordination with one another. Computer system 900 may transmit and receive messages, data, and instructions, including program, i.e., application code, through communication link 920 and communication interface 912. Received program code may be executed by processor 904 as it is received, and/or stored in disk drive 910, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
receiving data associated with an order;
retrieving other data associated with one or more resources configured to fulfill the order;
using the other data and one or more gating criteria to generate a determination to dynamically allocate the data associated with the order; and
dynamically allocating the data to one or more of a plurality of services using the determination.

2. The method of claim 1, wherein the data is transferred using a message.

3. The method of claim 1, wherein the data is transferring using a message configured using JSON.

4. The method of claim 1, wherein the data is received from an application installed on a client, the client being in data communication with a system configured to dynamically allocate the data to the one or more of the plurality of services using the determination.

5. The method of claim 1, wherein the data is associated with an order to retrieve food from a mobile food vendor.

6. The method of claim 1, wherein the data is associated with an order to purchase a concession from a sports venue.

7. The method of claim 1, wherein the gating criteria comprises a time period.

8. The method of claim 1, wherein the gating criteria comprises additional data configured to describe one or more available resources from a provider.

9. The method of claim 8, wherein at least one of the one or more available resources from the provider includes an ingredient configured to be used to prepare a meal.

10. The method of claim 8, wherein at least one of the one or more available resources from the provider includes a threshold indicating a maximum number of allowable orders.

11. The method of claim 8, wherein at least one of the one or more available resources from the provider includes a determination of one or more locations that are within a proximity to a source of the order.

12. A system, comprising:
a memory configured to store data associated with an order; and
a processor configured to receive data associated with an order, to retrieve other data associated with one or more resources configured to fulfill the order, to use the other data and one or more gating criteria to generate a determination to dynamically allocate the data associated with the order, and to dynamically allocate the data to one or more of a plurality of services using the determination.

13. A computer program product embodied in a computer readable medium and comprising computer instructions for:
receiving data associated with an order;
retrieving other data associated with one or more resources configured to fulfill the order;
using the other data and one or more gating criteria to generate a determination to dynamically allocate the data associated with the order; and
dynamically allocating the data to one or more of a plurality of services using the determination
